(19) United States
(12) Patent Application Publication
(10) Pub. No.: US 2014/0119039 A1
(43) Pub. Date: May 1, 2014

(54) VEHICLE LIGHT DEVICE WITH LIGHT GUIDE COVER

(71) Applicant: Wei-Ting LIN, Taipei City (TW)

(72) Inventor: Wei-Ting LIN, Taipei City (TW)

(21) Appl. No.: 13/723,154

(22) Filed: Dec. 20, 2012

(30) Foreign Application Priority Data
Oct. 29, 2012 (TW) 101220870

(51) Int. Cl. B60Q 1/30; B60Q 1/46

(52) U.S. Cl. CPC B60Q 1/30; B60Q 1/46
USPC 362/511

(57) ABSTRACT

A vehicle light device includes a light source board and a light guide cover. The light source board include a plurality of light emitting diodes (LEDs) mounted thereon to emit a light. The light guide cover is disposed on the light source board and covering the LEDs to make the emitted light uniformly illuminated. The vehicle light device has a simple structure, which the LED lamp holder and the reflecting element are eliminated. Therefore, the structure of the vehicle light device is thin and reduced-volume, that is easy to mass-produce with cost down.

### BACKGROUND OF THE INVENTION

1. Field of Invention

The present invention relates to a vehicle light device, in particular to adapt for headlight, interior light, side mirror signal light, reverse light, a right and left turn-signal light, a brake light and a tail-light.

2. Related Art

A vehicle such as a motorcycle, an automobile or a truck uses a plurality of lights mounted externally on the vehicle to indicate certain information about the vehicle to other drivers and pedestrians. Typically, such lights are mounted on the rear end of the vehicle on both left and right sides of the vehicle's rear end. A brake light is used to inform others that the driver has applied the brake and is thus beginning to slow down the vehicle. A tail light is used at night to indicate the presence of the vehicle to others. Indicator lights are used to inform others that the driver has signalled his/her intention to turn the vehicle either left or right, depending on which indicator light is turned on.

Vehicle manufacturers are rapidly adopting light emitting diodes (LEDs) as light sources for use in vehicles. LEDs offer various advantages over incandescent lamps, and in particular they can be mounted in relatively thinner packages, requiring for example less of the trunk volume to accommodate the lamp depth. Making lamps smaller is not a completely good thing. Signal lamps must be visually distinguishable so an observer can mentally separate the intended messages. With incandescent lamps, this is achieved by spacing them sufficiently far apart so the differing signals visually do not overlap or bleed into each other. LED lamps can also be separated, but LED lamps can be relatively more expensive, and multiple lamps may not be economic. There is then a need for a lamp system that uses LEDs, but provides distinguishable regions of illumination on a vehicle.

### SUMMARY OF THE INVENTION

This invention discloses a vehicle light device. The vehicle light device includes a light source board and a light guide cover. The light source board include a plurality of light emitting diodes (LEDs) mounted thereon to emit a light. The light guide cover is disposed on the light source board and covering the LEDs to make the emitted light uniformly illuminated. The vehicle light device of this invention has a simple structure, which the LED lamp holder and the reflecting element are eliminated. Therefore, the structure of the vehicle light device according to this invention is thin and reduced-volume, that is easy to mass-produce with cost down. The light guide cover has a better diffusion to make the emitted light uniformly illuminated. Also, the top diffusing surface and the side diffusing frame of the light guide cover are with diffusion property to diffuse the emitted light in almost all directions.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1A illustrates the cross-sectional view of the vehicle light device of this invention.

FIG. 1B illustrates the respective view of the vehicle light device of this invention.

FIG. 2 is a block diagram illustrating an equivalent circuit of the vehicle light device of this invention.

FIG. 3 is a block diagram illustrating an equivalent circuit of another embodiment of the vehicle light device of this invention.

FIGS. 4A and 4B illustrate another embodiment of the vehicle light device of this invention according to FIG. 3.

FIGS. 5A, 5B, 6A, 6B, 7A and 7B illustrate embodiments of the vehicle light device of this invention when utilizing in the vehicle.

### DETAILED DESCRIPTION OF THE INVENTION

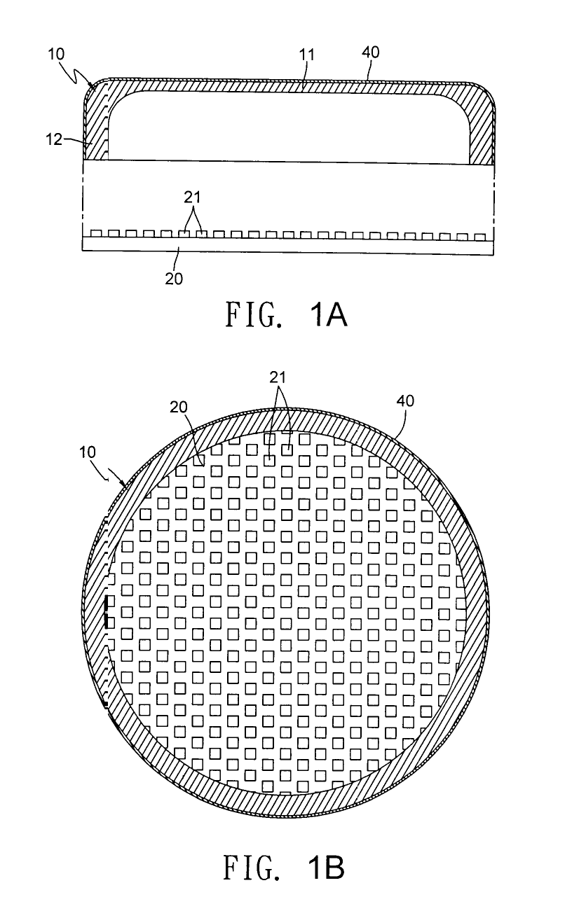

FIG. 1A illustrates the cross-sectional view of the vehicle light device of this invention. The vehicle light device of this invention includes a light guide cover 10 and a light source board 20. The light guide cover 10 includes a top diffusing surface 11 and a side diffusing frame 12. The light source board 20 includes a plurality of light emitting diodes (LEDs) 21. The LEDs 21 are mounted thereon to emit a light. In this embodiment, the LEDs 21 are single color LEDs. The light guide cover 10 is disposed on the light source board 20 and covering the LEDs 21 to make the emitted light uniformly illuminated. The side diffusing frame 12 extends from the edge of the top diffusing surface 11. The thickness of the side diffusing frame 12 is greater than the thickness of the top diffusing surface 11 to enhance the structure strength of the light guide cover 10. On the other hand, the emitted lights are diffused by the side diffusing frame 12 and the top diffusing surface 11. The top diffusing surface 11 may be a matte surface. Also, the light guide cover 10 is coated a light translucent layer 40 to improve the aesthetic appearance. Please refer to FIG. 1B, the LEDs 21 are arranged in a matrix.

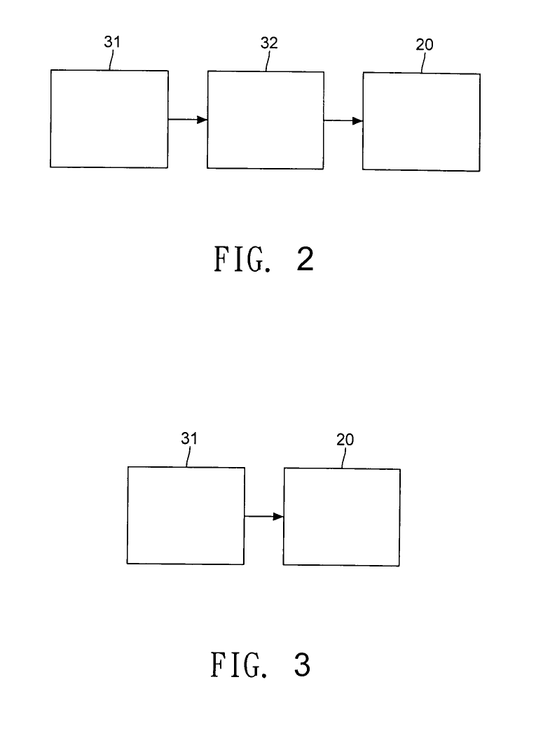

FIG. 2 is a block diagram illustrating an equivalent circuit of the vehicle light device of this invention. A control element 31 and a driver circuit 32 are electrically connected to the light source board 20. The light source board 20 has at least one printed circuit board (PCB) to carry the LEDs 21. When the control element 31 sends a driving signal to the driver circuit 32, the driver circuit 32 offers a working power to the light source board 20 to control the LEDs 21 to emit lights.

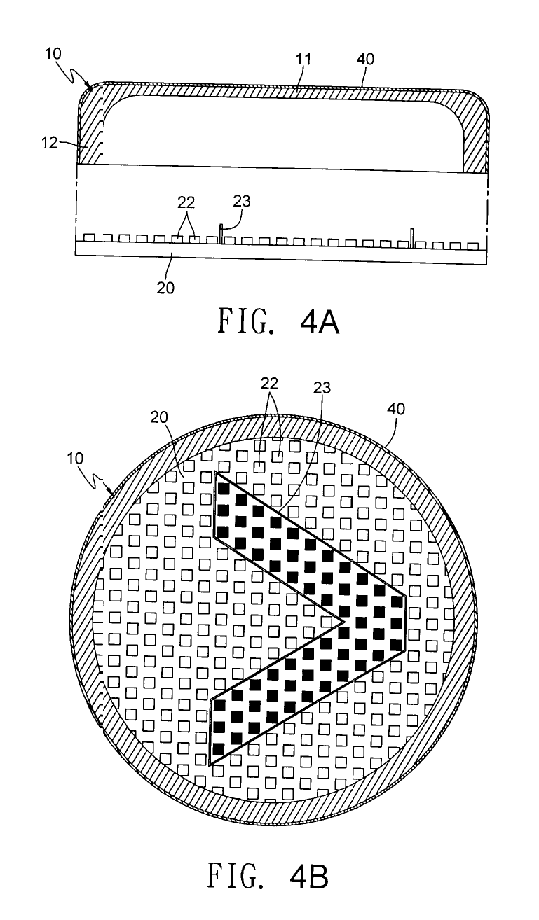

FIG. 3 is a block diagram illustrating an equivalent circuit of another embodiment of the vehicle light device of this invention. A control element 31 is electrically connected to the light source board 20, please also refer to FIG. 4A. The light source board 20 has at least one printed circuit board (PCB) to carry a plurality of full-color LEDs 22. When the control element 31 sends a control signal to the light source board 20, the embedded driver circuit will control the LEDs 21 to emit the lights with different colors according to the control signal. Therefore, the light source board 20 has a wide applicability. In this embodiment, please refer to FIGS. 4A and 4B, the light source board 20 includes a plurality of full-color light emitting diodes (LEDs) 22 mounted thereon to emit a light in at least one emission pattern with different colors. The light source board 22 further includes at least one light blocking walls 23 to form the emission pattern and to limit a light emitting angle of the LEDs within the emission pattern. As FIG. 4B shown, the light blocking walls 23 form a right turn-signal light. By the light blocking walls 23, the periphery of the right turn-signal light would be more clear. Also, the light guide cover 10 is coated a light translucent layer 40 to improve the aesthetic appearance.

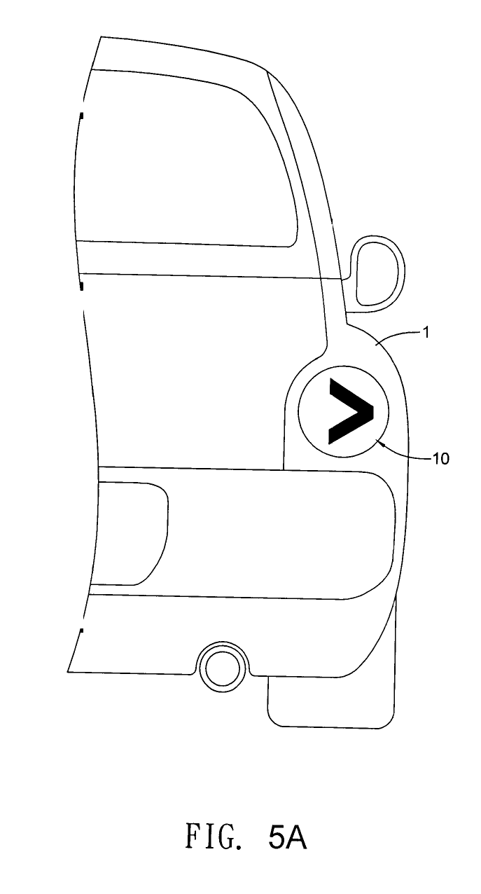

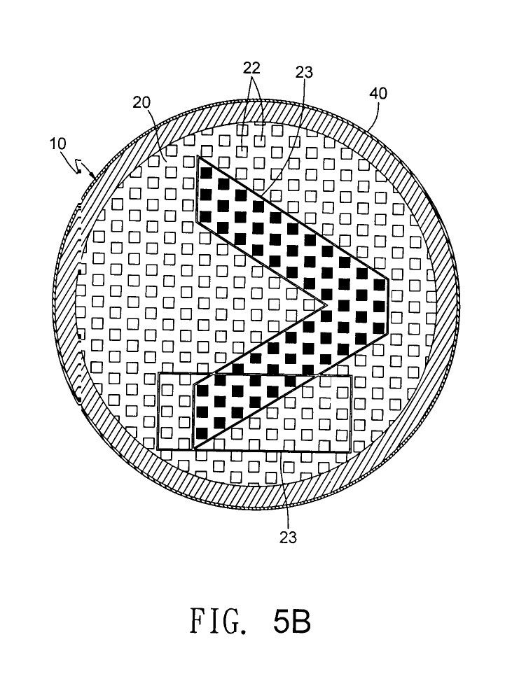

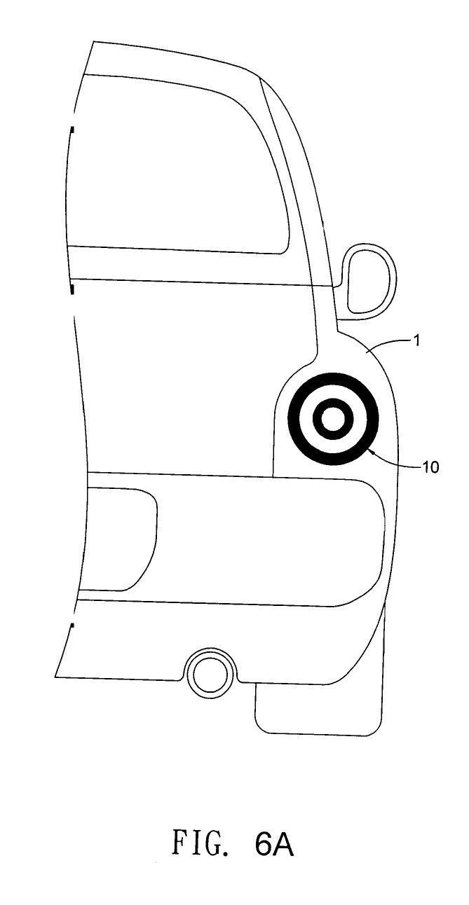

When utilizing in a vehicle 1, the vehicle light device of this invention may be a tail-light, please refer to FIGS. 5A-7B. The light source board 20 emits a light in at least one emission pattern with different colors according to the control signal. As refer to FIGS. 5A and 5B, the light source board 20 emits a right turn-signal light with amber color. By the light blocking walls 23 and the light guide cover 10, the turn-signal light is clear and uniform.

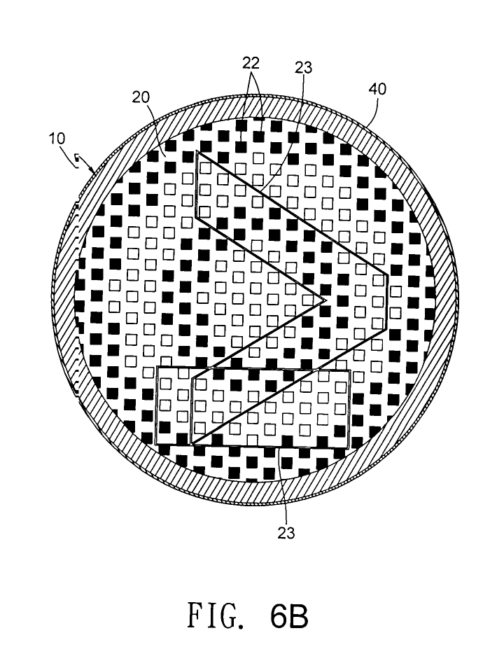

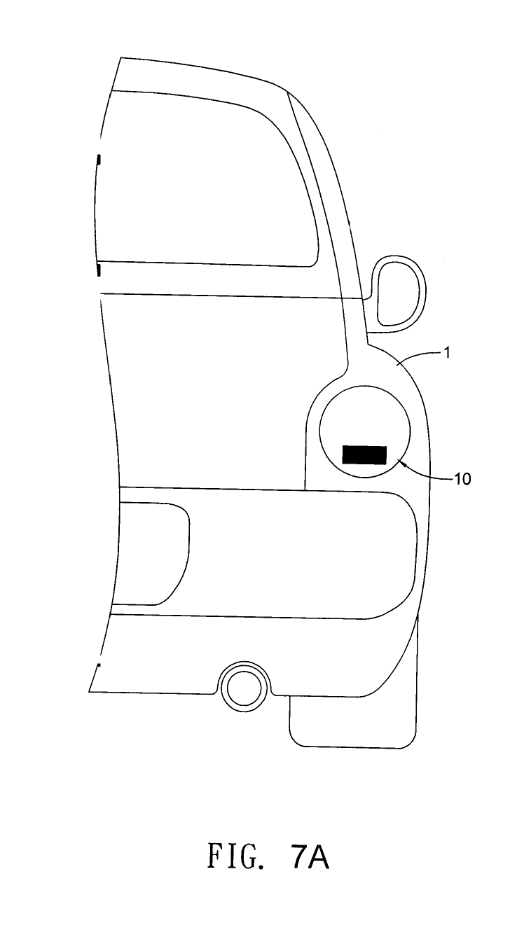

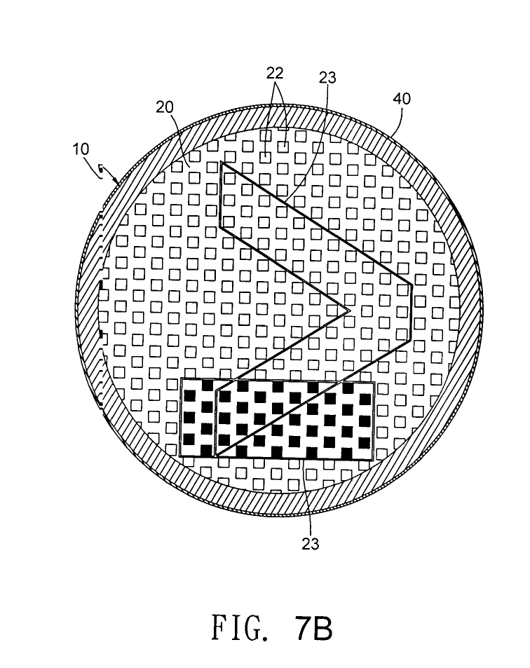

As refer to FIGS. 6A and 6B, the light source board 20 emits a brake light with red color. By the light guide cover 10, the brake light is uniform. As refer to FIGS. 7A and 7B, the light source board 20 emits a reverse light with white color. By the light blocking walls 23 and the light guide cover 10, the reverse light is clear and uniform. Please note, to simplify the structure of the light blocking walls 23, only the turn-signal light and the reverse light have the light blocking walls 23 to form the emission pattern as shown in FIG. 6B. However, it may also have the light blocking walls 23 to form the emission pattern of the brake light. Moreover, in this embodiment, all the LEDs 22 are full-color LEDs. The light source board 20 may also have single color or dual color LEDs in predetermined locations, or have two or more single color LEDs in the same position, to achieve the above-mentioned objects.

The vehicle light device of this invention has a simple structure, which the LED lamp holder and the reflecting element are eliminated. Therefore, the structure of the vehicle light device according to this invention is thin and reduced-volume, that is easy to mass-produce with cost down. The light guide cover has a better diffusion to make the emitted light uniformly illuminated. Also, the top diffusing surface and the side diffusing frame of the light guide cover are with diffusion property to diffuse the emitted light in almost all directions.

Furthermore, the vehicle light device of this invention may have different light source boards. For example, single light source board has single color LEDs to adapt for single light region. Multiple light source boards have single color LEDs to adapt for multiple light regions. Single light source board has full-color LEDs to adapt for multiple light region. Multiple light source boards have full-color LEDs to adapt for multiple light region and situations.

Further, the light guide cover may be colored all or part to combine more different colors with the LEDs.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A vehicle light device, comprising:
a light source board, including a plurality of light emitting diodes (LEDs) mounted thereon to emit a light; and
a light guide cover, disposed on the light source board and covering the LEDs to make the emitted light uniformly illuminated.

2. The vehicle light device of claim 1, wherein the light guide cover includes a top diffusing surface and a side diffusing frame, the side diffusing frame extends from the edge of the top diffusing surface to enhance strength.

3. The vehicle light device of claim 2, wherein a thickness of the side diffusing frame is greater than a thickness of the top diffusing surface.

4. The vehicle light device of claim 2, wherein the top diffusing surface is a matte surface.

5. The vehicle light device of claim 1, wherein the light source board further includes a driver circuit.

6. The vehicle light device of claim 1, wherein the LEDs are arranged in a matrix.

7. The vehicle light device of claim 1, wherein the light guide cover is coated a light translucent layer.

8. A vehicle light device, comprising:
a light source board, including a plurality of full-color light emitting diodes (LEDs) mounted thereon to emit a light in at least one emission pattern with different colors; and
a light guide cover, disposed on the light source board and covering the LEDs to make the emitted light uniformly illuminated.

9. The vehicle light device of claim 8, wherein the light guide cover includes a top diffusing surface and a side diffusing frame, the side diffusing frame extends from the edge of the top diffusing surface to enhance strength.

10. The vehicle light device of claim 9, wherein a thickness of the side diffusing frame is greater than a thickness of the top diffusing surface,

11. The vehicle light device of claim 9, wherein the top diffusing surface is a matte surface.

12. The vehicle light device of claim 8, wherein the light source board further includes a driver circuit.

13. The vehicle light device of claim 8, wherein the LEDs are arranged in a matrix.

14. The vehicle light device of claim 8, wherein the light guide cover is coated a light translucent layer.

15. The vehicle light device of claim 8, wherein the light source board includes at least one light blocking walls to form the emission pattern to limit a light emitting angle of the LEDs within the emission pattern.

16. The vehicle light device of claim 8, wherein the emission pattern includes a reverse light, a right and left turn-signal light, a brake light and a tail-light.
